(19) United States
(12) Patent Application Publication
(10) Pub. No.: US 2010/0325627 A1
(43) Pub. Date: Dec. 23, 2010

(54) System for Deploying Software Components on Computation Units that are Limited in Terms of Processing Capacity

(75) Inventors: Frederic Lafaye, Argenteuil (FR); Eric Nicollet, Cergy (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/740,814

(22) PCT Filed: Oct. 30, 2008
(86) PCT No.: PCT/EP2008/064748

§ 371 Date: Sep. 1, 2010

(30) Foreign Application Priority Data
Oct. 31, 2007 (FR) 07/07685

(51) Int. Cl. G06F 9/445

(52) U.S. Cl. 717/177

(57) ABSTRACT

The present invention relates to a system comprising a software platform for deploying components on computation units that are limited in processing capability. The host platform offers a core framework means of deploying and executing components on the computation units, said means comprising:
a means for loading and/or unloading the object code of a component on a computation unit,
a means for executing and/or stopping said component,
a means for invoking the functions of said component,
a means for connecting and/or disconnecting a deployed component to and from other components.

The invention applies notably to the reconfiguration of equipment based on embedded computers with real-time constraints, in particular for software radios.

The present invention relates to a system comprising a software platform for deploying components on computation units that are limited in processing capability. The invention applies notably to the reconfiguration of equipment based on embedded computers with real-time constraints, in particular for software radios.

The computation systems designed to adapt to multiple software configurations are now broadly developed. For fixed computers, these systems rely on core frameworks which use often resource-intensive environments with which to dynamically deploy components on a number of computation units.

However, when these systems are embedded and subject to strong real-time constraints, major difficulties occur, these difficulties being notably associated with the imposed capacity limits, both in terms of memory and in terms of computation power. As an example, a computer incorporated in a mobile software radio terminal must, on the one hand, be able to adapt to new waveforms, and therefore be designed on the basis of an open architecture, and on the other hand, be able to switch rapidly from a communication mode based on one waveform to a communication mode based on another waveform, and therefore rapidly modify its software configuration.

To address this technical problem, the systems rely on standards such as SCA (Software Communications Architecture) and LightWeight CCM (Corba Component Model). A core framework, for example Core Framework SCA, interacts with a target runtime environment, via standardized interfaces, such as ExecutableDevice and Resource for SCA, in order to deploy and execute software components on a number of computation units.

The current core frameworks rely on target runtime environments based on an operating system according to the POSIX standard and a middleware architecture of CORBA type (Common Object Request Broker Architecture). However, the CORBA architecture is not suited to embedded systems subject to strong real-time constraints. A number of alternatives have therefore been proposed.

Solutions relying on the D&C core framework from the OMG (Object Management Group) have been developed, but these solutions do not allow for dynamic link editing of code. Furthermore, they do not comply with the SCA standard.

Moreover, studies have made it possible to dynamically load code on a non-CORBA target environment, but just one component can be loaded for each computation unit, the connection addresses of this component being, furthermore, fixed in advance in the object code, which establishes a strong coupling between the core framework and the deployed component.

Finally, other studies, notably in the context of the JTRS (Joint Tactical Radio System) program, have culminated in the definition of an abstraction layer or MHAL (Modem Hardware Abstraction Layer) to produce another target runtime environment. However, this MHAL does not offer any deployment service and does not allow interoperability with the CORBA middleware.

One aim of the invention is to propose a system with which it is possible to reconfigure an embedded computation center consisting of a number of processors, some of which have greatly limited processing capabilities, by deploying and executing on these processors software components that are able to communicate with one another. To this end, the subject of the invention is a system comprising at least one main processor and one or more secondary computation unit(s), a core framework executed on the main processor to deploy and execute one or more software components on at least one secondary computation unit, characterized in that at least one secondary computation unit is a processor that is limited in processing capability, said processor executing a host platform offering the core framework means of deploying and executing components on said processor, said means comprising:
a means for loading and/or unloading the object code of a component on a computation unit,
a means for executing and/or stopping said component,
a means for invoking the functions of said component,
a means for connecting and/or disconnecting a deployed component to and from other components,
   and in that said secondary computation unit (102) comprises cross connectivity services.

According to one embodiment, the core framework complies with the “OMG Software Radio” standard, and the components deployed via the host platform implement the Resource interface of this standard.

According to one embodiment, the processor or processors executing the host platform are digital signal processors (DSP).

According to one embodiment, the means for loading and/or unloading a component on a computation unit creates a file on the computation unit, the file containing the object code of the component to be loaded and a table of symbols of this object code in order to perform a dynamic link editing between the host platform and said component during the instantiation of said component on a computation unit.

According to one embodiment, the means for connecting and/or disconnecting a first deployed component to/from other deployed components employs a cross-serializing service resident on the deployment computation unit of the first component.

Other features will become apparent from reading the following detailed description given as a nonlimiting example, in light of the appended drawings which represent:

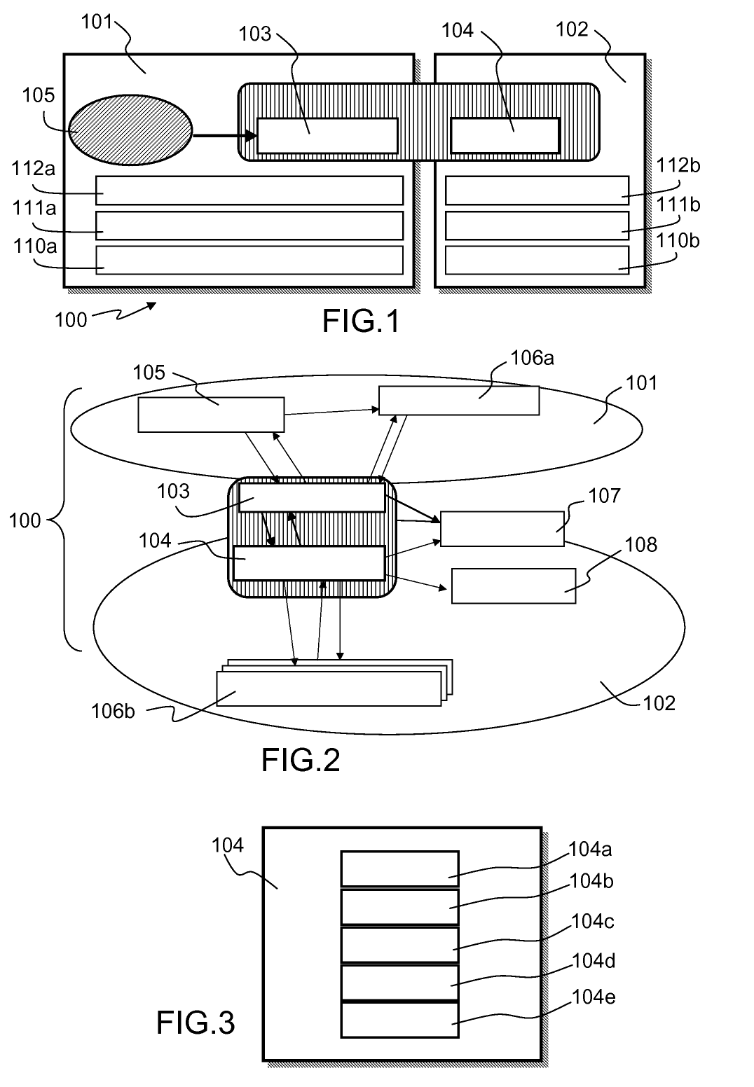

FIG. 1, a block diagram of a system comprising a platform according to the invention;

FIG. 2, a block diagram illustrating an example of the deployment of components on a computation unit provided with a platform according to the invention;

FIG. 3, an illustration of the method of deploying software components on a computation unit via a platform according to the invention;

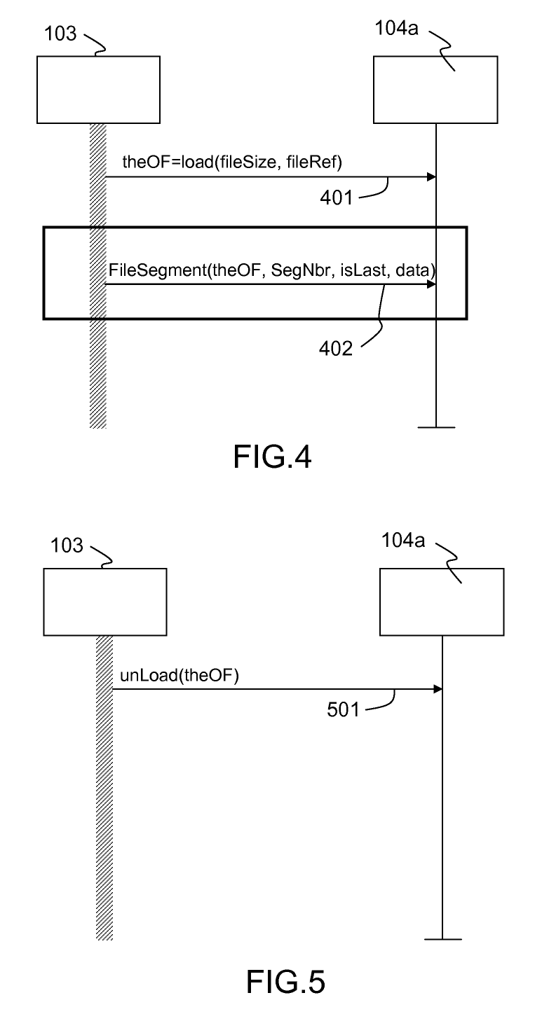

FIG. 4, a diagram representing an example of the method of loading code executed via a platform according to the invention;

FIG. 5, a diagram representing an example of the method of unloading code executed via a platform according to the invention;

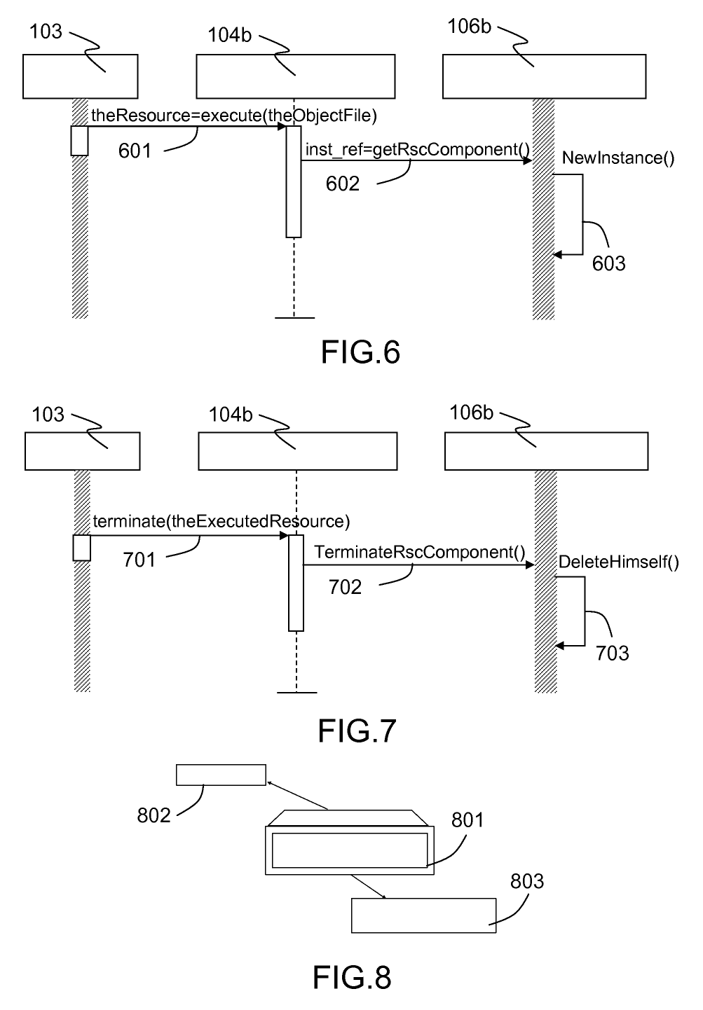

FIG. 6, a diagram representing an example of the method of creating an instance of a component deployed via a platform according to the invention;

FIG. 7, a diagram representing an example of the method of destroying an instance of a component deployed via a platform according to the invention;

FIG. 8, a block diagram illustrating constraints that a component deployed by the platform according to the invention must observe,

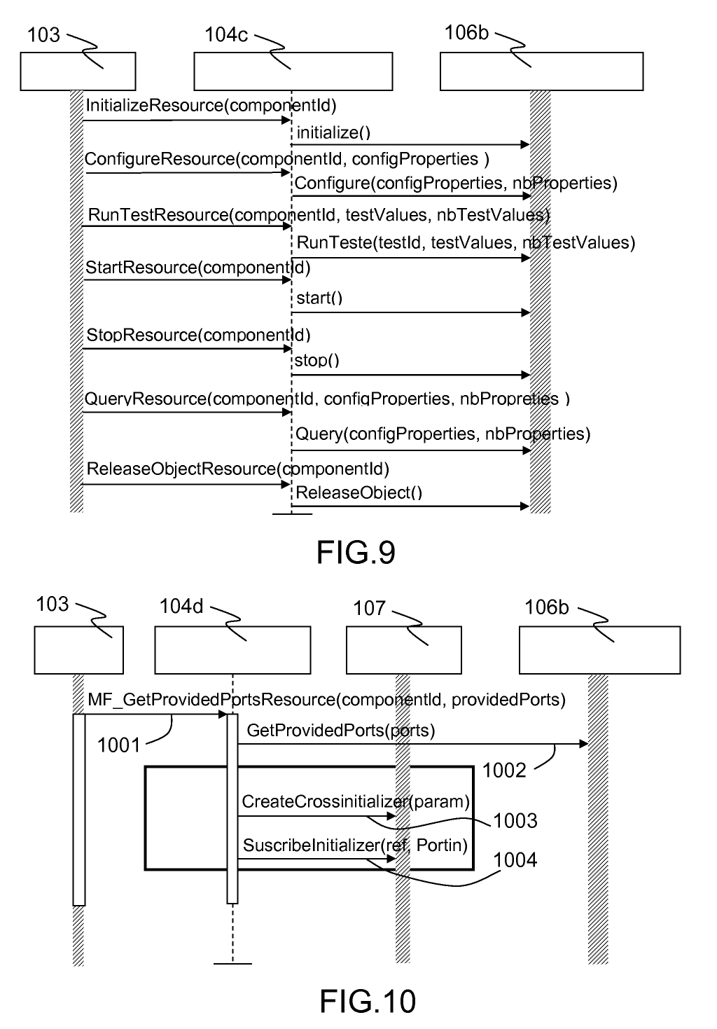

FIG. 9, a diagram representing the calls to the functions of the component deployed via a platform according to the invention;

FIG. 10, a diagram illustrating the referencing of the ports of a component by a core framework, via a platform according to the invention;

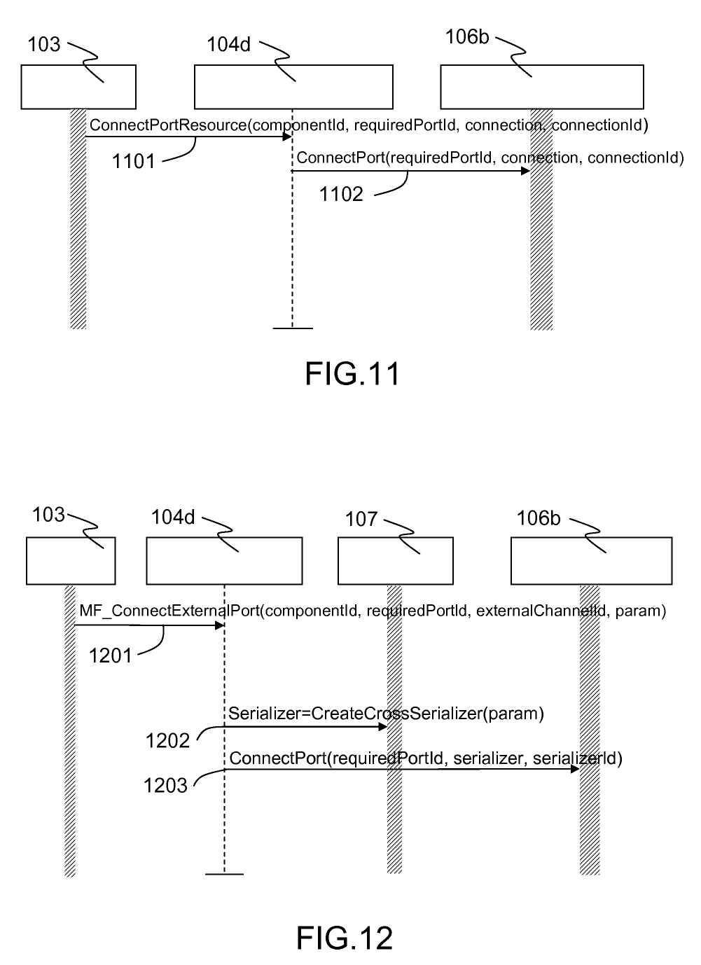

FIG. 11, a diagram illustrating the connection, via a platform according to the invention, of a first component to another component executed on one and the same computation unit;

FIG. 12, a diagram illustrating the connection, via a platform according to the invention, of a first component to another component executed on a different computation unit;

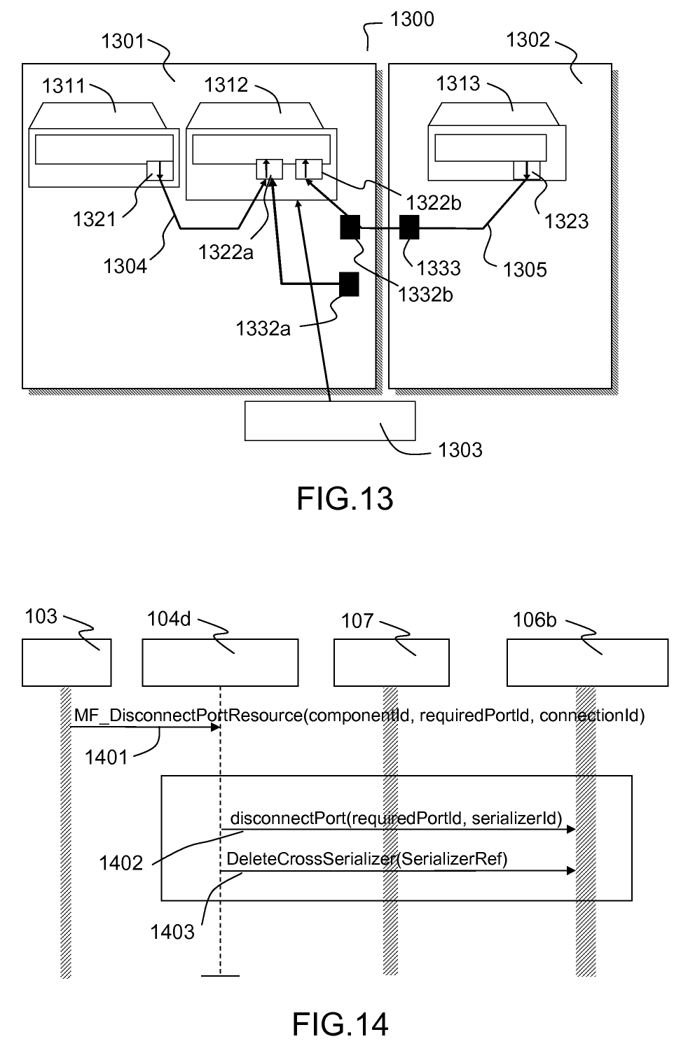

FIG. 13, a block diagram summarizing the steps involved in connecting several components via a platform according to the invention;

FIG. 14, a diagram illustrating the disconnection of components previously connected via the platform according to the invention.

In the interests of clarity, the same references in different figures denote the same elements.

FIG. 1 is a block diagram of a system comprising a platform according to the invention, said platform being designated “μF platform” hereinafter in the text, μF standing for “micro-framework”.

The μF platform offers the core framework, regardless of the runtime environment on which it is based (for example CORBA), a support with which to dynamically deploy components on processors that are limited in processing capability, these processors being, in the example, DSPs, the acronym standing for Digital Signal Processors. The embodiment shown in the example applies more particularly to the framework defined by the SCA standard and by the closely related standard “Platform Independent Model & Platform Specific Model for Software Radio Components”, the latter standard being more simply designated “OMG Radio Software” hereinafter in the text. Therefore, in the example, the components comply with the Resource interface of the “OMG Radio Software” standard. Furthermore, the μF platform can be executed on other types of processors, such as processors of ARM (Advanced RISC Machine) type.

A system 100 comprises a main processor 101 and a secondary computation unit 102 that is limited in processing capability, in this case a DSP 102. The runtime environment of the main processor 101 consists of a hardware layer 110a, an operating system 111a, and a middleware layer 112a (CORBA for example). The runtime environment of the DSP 102 comprises a hardware layer 110b, usually different from the hardware layer 110a of the main processor 101, an operating system 111b, and a middleware layer 112b, the latter two elements also possibly being different from those used on the main processor 101. Thus, the main processor 101 and the DSP 102 rely on generally dissimilar runtime environments, these differences being notably due to the different roles that are assigned to these processors and their unequal capabilities. A core framework 105 present on the main processor can be used to reconfigure the system by deploying software components on its computation units, in the example, on the main processor 101 and on the DSP 102. This deployment is performed by virtue of a μF platform 104 present on each of the secondary computation units (in the example, on the DSP 102), this platform being associated with an ExeDevice stub 103 on the main processor 101. Regardless of the middleware layers 112a, 112b used on the computation units, the μF platform 104, detailed hereinbelow, is able to allow the deployment of software components.

More specifically, the μF platform can be implemented in a runtime environment of any type (CORBA or other) when this environment offers mechanisms for dialog with the runtime environment of the core framework. These dialog mechanisms are designated by the term “crossconnectivity” hereinafter. Thus, the messages of the ExecutableDevice and Resource interface are serialized according to the type of crossconnectivity used.

FIG. 2 is a block diagram illustrating an example of the deployment of components within the system 100.

The core framework 105 deploys a first software component 106a on the main processor 101 and a second software component 106b on the DSP 102. In the example, the middleware layer 112a of the main processor 101 is CORBA, and the middleware layer 112b of the DSP 102 consists of resident crossconnectivity 107 and internal connectivity 108 services, these services being detailed hereinbelow. The arrows in FIG. 2 represent the message transmissions within the system 100.

Each component to be executed by a computation unit is deployed dynamically, in the example via the OMG Software Radio ExecutableDevice interface. Each of these components implements the OMG Software Radio Resource interface, and can be connected to other software components—present on the same computation unit or different computation units—via connecting ports, just as in the CORBA component model.

As a reminder, the concept of port covers any form of software responsible for the routing of “job” syntaxes specific to a component by serializing them on available connectivity mechanisms. Such job syntaxes are generally expressed in languages independent of the target programming language used to produce the components, these independent languages being, for example, UML (Unified Modeling Language) or IDL (Interface Definition Language).

For each deployed component, an ExeDevice stub 103 is created on the core framework, this stub providing the core framework with the functions of the Resource interface and the ports of the component deployed on the computation unit. According to another embodiment, just one stub is created, this stub being responsible for all the components.

The μF platform 104 is software resident on the DSP 102 and executing the following steps:
i. it loads the object code of a first component on the processor DSP 102;
ii. it creates an instance of this first component, additional access ports being created on the main processor 101 (on an access stub specific to this component or on an access stub common to several components);
iii. it connects ports of the first component to ports of other deployed components, whether they are loaded on the same DSP as the first component or on another processor, this other processor also possibly being able to execute a runtime environment different from that executed by the DSP 102 hosting the first component.

In order to implement the abovementioned functionalities, the μF platform 104 comprises the following modules, as illustrated in FIG. 3:
a first PROC_Loader module 104a for loading and/or unloading the object code of a component on a computation unit;
a second PROC_ExecutionController module 104b for executing and/or stopping the execution of a component deployed on a computation unit;
a third PROC_ResourceManager module 104c for accessing the functions defined by the Resource interface, an interface that is described, for example, by the specifications of the OMG Software Radio standard;
a fourth PROC_ConnectionFactory module 104d for connecting the ports of the component deployed on the computation unit, on the one hand, with the ports of the components deployed on the same computation unit, and on the other hand, with the ports of the components executed on other computation units;
a fifth PROC_DeviceManagement module 104e for producing the SCA commands allocateCapacity( ) and deallocateCapacity( ), and error management and self-registration with the core framework 105; in other words, the emission of a signal by the μF platform 104 to the core framework 105 when the μF platform 104 is ready.

The method of loading code of a ResourceComponent component on the DSP 102 is executed by the PROC_Loader module 104a according to a nominal mode described hereinbelow with respect to FIG. 4. Upon receipt of a load request 401 sent by the ExeDevice stub 103, the request being parameterized with a file size and reference, the PROC_Loader module 104a creates an Object File in the memory of the DSP 102, in order to store therein the code of the ResourceComponent component. It returns the reference of this file to the ExeDevice stub 103 present on the main processor 101 (FIG. 1) that is executing the core framework 105. Then, 402, the code of the ResourceComponent component is transmitted to the PROC_Loader 104a one segment at a time, each of said segments containing the reference to the Object File file, the index of the segment (beginning in the example at 0), and, for the final segment, an end indicator. The object code of the component is transmitted to the DSP 102 in the form of a file in BOFF (Basic Object File Format) format, an example of this format being supplied in the appendices. This BOFF-format file contains, in addition to the object code of the component, the addresses of the functions of the component to be invoked by the μF platform 104. This file can therefore be used for a dynamic link editing at the time of the creation of an instance of the component. The example of the BOFF format is not limiting; any format that allows the object code of the component to be transmitted and a dynamic link editing to be performed upon creation of the component can be employed.

After having sent a load request or a file segment, the ExeDevice stub 103 waits for an acknowledgement response from the PROC_Loader module 104a for a given duration. If no response to a load request arrives during this time, the ExeDevice stub 103 cancels the load operation. If no response arrives after the transmission of a file segment, an abort message is sent by the ExeDevice stub 103 to the PROC_Loader module 104a and the load operation is canceled. Moreover, if the PROC_Loader module 104a waits for a file segment for an abnormally long time, it must abort the load operation and stop sending responses to the ExeDevice stub 103, even if it receives a file segment subsequently.

Furthermore, in certain cases, the acknowledgement response may reflect a failure, notably if the reference of the file to be loaded indicates that the file has already been loaded previously or if it has proved impossible to create the file on the DSP 102.

The method of unloading a component code comprises the following single step 501, illustrated by FIG. 5: upon receipt of an unload command, the PROC_Loader module 104a deletes the referenced Object File. The reference given as a parameter of the unload command must be a reference used in a loading step. After the unloading step 501, the ResourceComponent component can no longer be executed on the DSP 102 until it has been reloaded.

The PROC_ExecutionController module 104b starts or stops the processes or the threads of a component loaded on a computation unit.

FIG. 6 illustrates the method of creating an instance of a component. Upon receipt of a create command 601 sent by the ExeDevice stub 103, the PROC_ExecutionController module 104b evokes a method 602 of the loaded ResourceComponent component 106b, the method in this case being getRscComponent( ), in order to create an instance 603 of this component and return the reference to this instance. It should be noted that the ResourceComponent component 106 must necessarily implement the “getRscComponent( )” method. In order for the μF platform to have access to the getRscComponent( ) and terminateRscComponent( )methods, the addresses of these functions are specified in the BOFF-format file.

FIG. 7 illustrates the method of destroying an instance of a component. Upon receipt of a destroy command 701 sent by the ExeDevice stub 103, the PROC_ExecutionController module 104b invokes a method 702 of the ResourceComponent component 106, the method in this case being terminateRscComponent( ), in order to destroy the instance 703 of this component. It should be noted that the ResourceComponent component must necessarily implement the “terminateRscComponent( )” method.

FIG. 8 illustrates, with a diagram, constraints that a component deployed by the μF platform must observe, in particular in the OMG Software Radio context. The component 801 must, on the one hand, to be consistent with the OMG Software Radio standard, implement the Resource interface 802, and on the other hand, implement the abovementioned creation and destruction methods 803, that is to say getRscComponent( ) and terminateRscComponent( ). In another embodiment, outside the OMG Software Radio or SCA context, the component would implement functions other than those defined by the Resource interface.

FIG. 9 illustrates, with a diagram, the execution of various operations defined by the Resource interface and implemented by the ResourceComponent component. A command 801, comprising a parameter specifying the identifier of the component to be invoked, is sent by the ExeDevice stub 103 and is received by the PROC_ResourceManager module 104c, which invokes, 802, the corresponding function in the component being executed on the DSP 102. In the example, the operations of the Resource interface taken over by the PROC_ResourceManager module 104c are notably the initialize( ), releaseObject( ), configure( ), query( ), start( ) and stop( ) functions, these functions being described in the specifications of the OMG Software Radio standard.

To connect the deployed components to one another, the platform uses the crossconnectivity service 107 resident on the DSP 102, this service being able to be modeled as a cross-serializer defining the following methods:
SerializerRef create CrossSerializer(ParamCrossSerializer) to create a serializer, that is to say, an object that can be used to send data;
deleteCrossSerializer(SerializerRef) to destroy a previously created serializer;
invocateSerializer(SerializerRef, Data) to send data via the serializer.

Moreover, the μF platform 104 defines, for each port of a component:
a first InternalChannelId reference that can be used to connect two components occupying the same memory space (in other words, two components deployed on the same computation unit),
a second ExternalChannelId reference conveyed through the crossconnectivity service 107.

The PROC_ConnectionFactory module 104d is used to execute the getProvidedPorts( ) and connect( ) operations defined in the specifications of the OMG Software Radio standard and respectively used to load the references of the incoming ports of a component and to connect two components together. The steps for connecting several components together are detailed hereinbelow.

FIG. 10 illustrates, with a diagram, the referencing of the ports of a component by the core framework, via the PROC_ConnectionFactory module 104d. Firstly, an MF_GetProvidedPortsResource( ) request 1001 is sent by the ExeDevice stub 103 to the PROC_ConnectionFactory module 104d to request the incoming ports of a component. This request is parameterized by the identifier componentId of the component concerned. The PROC_ConnectionFactory module 104d relays this request by making a call 1002 to the getProvidedPorts( ) function of the component specified by the identifier componentId. In return, the component supplies the PROC_ConnectionFactory module 104d with a ProvidedPorts data structure containing the InternalChannelId references for each of its incoming ports.

Then, the PROC_ConnectionFactory module 104d makes a call 1003, via the CreateCrossInitializer( ) function, to the crossconnectivity services 107 to create a deserializer, that is to say, a communication channel for each of the references to the incoming ports of the component. This channel is, for example, a network connector (or “socket”), parameterized with an IP address, a port number and the ExternalChannelId reference created by the CreateCrossInitializer( ) function. The incoming port is then associated with the channel by a call 1004 to the SubscribeInitializer( ) function, which takes as a parameter the reference ref of the channel created previously and the reference of the incoming port PortIn.

The deserializers are deleted by the PROC_ResourceManager module 104c upon receipt of a releaseObject( ) deallocation request.

FIG. 11 illustrates, with a diagram, the connection of a first component to a second component executed on the same computation unit.

The connection is set up in two steps. Firstly, a ConnectPortResource( ) request 1101 is sent by the ExeDevice stub 103 to the PROC_ConnectionFactory module 104d. This request is parameterized with the identifier componentId of the component concerned. Secondly, the PROC_ConnectionFactory module 104d relays the request 1101, via a call 1102 to the connectPort( ) function of the component specified by the componentId identifier. This call 1102 to the connectPort( ) function is parameterized with the requiredPortId reference of the outgoing port of the first component and with the connection reference of the incoming port of the second component. The connection reference of the second component is obtained by virtue of the getProvidedPorts( ) function illustrated in FIG. 10. In the example, a third connectionId parameter is an identifier of the connection between these two components.

FIG. 12 illustrates, with a diagram, the connecting of a first component with another component executed on a different computation unit.

The connection is set up in three steps. Firstly, an MF_ConnectExternalPort( ) request 1201 is sent by the ExeDevice stub 103 to the PROC_ConnectionFactory module 104d. This request is parameterized with the componentId identifier of the component concerned. Secondly, a serializer is created via the CreateCrossSerializer( ) function by entering as a parameter the reference of the incoming port of the second component and the connection parameters (IP address, port number), the reference of this serializer being returned. Thirdly, the PROC_ConnectionFactory module 104d relays the MF_ConnectExternalPort( ) request 1201 with a call 1203 to the connectPort( ) function of the component specified by the componentId identifier. This call 1203 to the connectPort( ) function is parameterized with the requiredPortId reference of the outgoing port of the first component and by the serializer reference of the serializer in order to connect this outgoing port with the serializer.

An acknowledgement response from the PROC_ConnectionFactory module 104d to the ExeDevice stub 103 indicating a failure of the connection occurs when the reference of the component is unknown and/or when the reference of the specified port is unknown.

FIG. 13 summarizes, in a block diagram, the steps described in FIGS. 10, 11 and 12. A system 1300 comprises a core framework 1303 and two computation units 1301, 1302 on which components are deployed. The first computation unit 1301 executes a first component 1311 and a second component 1312, whereas the second computation unit 1302 executes just one, a third, component 1313. The connection of the second component 1312 deployed on the first computation unit 1301 with the other two components 1311, 1313 is required.

Initially, a call to the getProvidedPorts( ) function is used to obtain the references of the incoming ports of the second component 1312 and to create a deserializer 1332a, 1332b on the first computation unit 1301 for each of these ports.

Secondly, a call to the ConnectPortResource( ) function enables the first component 1311 to connect one of its outgoing ports 1321 to an incoming port 1322a of the second component 1312. This is a connection with an incoming port reference of InternalChannelId type. The messages conveyed between the first 1311 and second 1312 components are not serialized, therefore the first deserializer 1331 created for this first port 1322a is not used.

Thirdly, a call to the MF_ConnectExternal( ) function enables the third component 1313, executed on another computation unit than the second component 1312, to connect one of its outgoing ports 1323 to an incoming port 1322b of this second component 1312 via a serializer. This serializer 1333 is created on the second computation unit 1302. This is a connection with an incoming port reference of ExternalChannelId type.

FIG. 14 illustrates the steps used to delete the connections created with the ConnectPortResource( ) and MF_ConnectExternal( ) functions.

Upon receipt of a disconnect request MF_DisconnectPortResource( ) 1401 parameterized with the componentId identifier of the component involved in the disconnections, the PROC_ConnectionFactory module 104d deletes each connection. If a connection has been set up with the external connect command MF_ConnectExternalPort( ), the PROC_ConnectionFactory module 104d deletes the corresponding serializer 1403.

One advantage of the system according to the invention is that it allows for the use of few memory resources, because it does not necessarily rely on bulky middleware such as CORBA. Furthermore, the system does not require any modification of the core framework and can be ported to many runtime environments.

### APPENDICES

BOFF file

A BOFF-format file is a file containing the information needed for the dynamic link editing of the code during its execution.

The table below explains the general structure of such a file:

File Header
Optional Information
Symbol Table
Section 1 Header
...
Section n Header
Raw Data for Section 1
...
Raw Data for Section n
String Table

The header is based on the header of a COFF (Common Object File Format) file, but some of the fields take on a different meaning here.

typedef struct {

| unsigned short f_magic; | /* magic number | */ |
|---|---|---|
| unsigned short f_nscns; | /* number of sections */ | |
| unsigned long f_timdat; | /* time & date stamp pointer */ | |
| unsigned long f_symptr; | /* file pointer to symtab | */ |
| unsigned long f_nsyms; | /* number of symtab entries | */ |

| | | |
|---|---|---|
| unsigned short f_opthdr; | /* sizeof(optional hdr) | */ |
| unsigned short f_flags; | /* flags | */ |

} BOFF_FILHDR;

The above structure is at the start of the object.

f magic—magic number

This field contains a constant value common to all the BOFF-format files, which is used to identify the file as being in the BOFF format.

f nscns—number of sections

The number of sections (and therefore of section headers) contained in this file.

f timdat—creation time and date pointer

The pointer indicates the time and date of creation of the BOFF file.

f symptr—symbols table pointer

The symbols table pointer.

f nsyms—number of symbols in the table

The number of symbols in the symbols table.

f opthdr—optional header size

The number of additional octets following the header of the file, before the symbols section begins.

f flags

These flags supply additional information concerning the state of this BOFF file (executable file or object file, 32 bit or otherwise file coding).

BOFF file optional header

The optional header immediately follows the header of the BOFF file. The size of this header is stored in the header's f_opthdr field. This number of octets must be read whatever the expected size of the optional header.

Example of optional waveform header:

typedef struct {

| unsigned short magic; | /* type of file */ | |
|---|---|---|
| unsigned long f_infosymptr; | /* file info pointer | */ |
| char vstamp[10]; | /* version stamp | */ |

| | |
|---|---|
| unsigned long checksum; | /* checksum on data of the file */ |
| } WF_OPTHDR; | |

magic—magic number

The high order octet represents the optional header type. The low order octet represents the version of the format used.

f_infosymptr—file information symbol pointer

vstamp—version string

The version indicator.

Checksum—CRC (Cyclic Redundancy Code)

The checksum is a CRC calculated with the following polynomial: x¹⁶+x¹²+x⁵+1

The computation starts at the header of the first symbol and ends at the end of the file.

BOFF file symbols table

Symbol structure:
typedef struct {

char symbName[E_SYMNMLEN];
unsigned short s_use;
unsigned long e_value;
} BOFF_SYMENT;

E_SYMNMLEN = 20

symbName—symbol name

s_use—the symbol type

The symbol type can be specified here, but the values depend on the application that uses the file. Only the values between 0 and 15 are used for the BOFF definition.

The table below gives the meanings of the values of this field for BOFF version 2.0:

| | |
|---|---|
| 0x00 | Reserved |
| 0x01 | External symbol |
| 0x02 | Internal symbol, not normally |
| | used by the application |
| 0x03-0xF | Reserved |

e value—the value of the symbol

For example, if the symbol represents a function, it contains the address of the function. The meaning of the value depends on the type of the symbol, which is only known to the user of the file or indeed specified in the s_use field.

typedef struct {

| char s_name[E_SECTNMLEN]; /* section name | | */ |
|---|---|---|
| unsigned long s_paddr; | /* physical address, aliased s_nlib | */ |
| unsigned long s_size; | /* section size */ | |
| unsigned long s_used; | /* section used | */ |
| unsigned long s_loaded; | /* section loaded | */ |
| unsigned long s_scnptr; | /* file ptr to raw data for section | */ |

| | |
|---|---|
| unsigned long s_flags; /* flags | */ |

} SCNHDR;
E_SECTNMLEN = 20

BOFF section header

This structure immediately follows a symbols table in the BOFF file.

s name—section name

The name of the section.

s paddr—physical address of the data block

The address at which the data block must be loaded in memory. For executables, this is the absolute address in the program space. For unlinked objects, this address is relative to the memory address of the object (that is to say the first section begins at zero offset).

s vaddr—virtual address of the data section

For this version, this field always contains the same value as s_paddr.

s size—data section size

The number of data octets stored in the file for this section.

s used—data section used

s loaded—data section loaded

s scnptr—data section pointer

The address of the data section in the file.

s flags—flag bits

These flags supply additional information for each block.

| Bit | Name | Meaning |
|---|---|---|
| 0x0020 | STYP_TEXT | If this flag is activated, it indicates that this |
| | | section contains only executable code. |
| 0x0040 | STYP_DATA | If this flag is activated, it indicates that this |
| | | section contains only initialized data. |
| 0x0080 | STYP_BSS | If this flag is activated, it indicates that this |
| | | section contains only uninitialized data and |
| | | does not have any data stored in the BOFF file. |

1. A distributed system comprising at least one main processor and one or more secondary computation unit(s), a core framework executed on the main processor to deploy and execute one or more software components on at least one secondary computation unit, wherein at least one secondary computation unit is a processor that is limited in processing capability, said processor executing a host platform offering the core framework means of deploying and executing components on said processor, said means comprising:
a means for loading and/or unloading the object code of a component on a computation unit,
a means for executing and/or stopping said component,
a means for invoking the functions of said component,
a means for connecting and/or disconnecting a deployed component to and from other components,
and in that said secondary computation unit comprises cross connectivity services.

2. The system as claimed in claim 1, the core framework complying with the “OMG Software Radio” standard, wherein the components deployed via the host platform implement the Resource interface of this standard.

3. The system as claimed in claim 1, wherein the processor or processors executing the host platform are digital signal processors.

4. The system as claimed in claim 1, wherein the means for loading and/or unloading a component on a computation unit creates a file on the computation unit, the file containing the object code of the component to be loaded and a table of symbols of this object code in order to perform a dynamic link editing between the host platform and said component during the instantiation of said component on a computation unit.

5. The system as claimed in claim 1, wherein the means for connecting and/or disconnecting a first deployed component to/from other deployed components employs a cross-serializing service resident on the deployment computation unit of the first component.
